(19) United States
(12) Patent Application Publication
(10) Pub. No.: US 2006/0098640 A1
(43) Pub. Date: May 11, 2006

(54) Universal transfer file for dvd

(75) Inventor: Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/541,988

(22) PCT Filed: Jan. 12, 2004
(86) PCT No.: PCT/IB04/00034

§ 371 Date: Jul. 11, 2005

(30) Foreign Application Priority Data
Jan. 14, 2003 (EP) 03100048.2

(51) Int. Cl. H04L 12/56

(52) U.S. Cl. 370/389

(57) ABSTRACT

This invention relates to a method for creating a transfer file, the file comprising an information block comprising information on a data block and the data block comprising a navigation field and the navigation field comprising a Relative Logical Block Number of the navigation field, the method comprising the steps of creating a transfer file by appending the data block to the information block, to a method for recording such a transfer file, to a playback device and to a recording device.

This invention relates to a method for creating a transfer file, the file comprising an information block comprising information on a data block and the data block comprising a navigation field and the navigation field comprising a Relative Logical Block Number of the navigation field, the method comprising the steps of creating a transfer file by appending the data block to the information block, to a method for recording such a transfer file, to a playback device and to a recording device

At present the DVD standard has introduced a standard format for storing data streams on an optical recording disc. For storing video streams the DVD+VR standard defines a structure in which the necessary information for playing back a video stream is stored on a DVD disc.

Now that a recordable and rewritable DVD disc is available the transfer of sections of a data stream from one device to a device able to record this data stream is becoming an important issue.

The data stream on a DVD disc is stored in a VTS block. This VTS block comprises a VTSI block which is an information block where information required for the proper playback of the data stream is stored. The VTS block further comprises a VOB block in which the actual data stream is stored. The VOB block comprises one or more VOBs and each VOB in turn comprises one or more VOBUs. For navigation purposes each VOBU comprises a navigation field from which the player can retrieve information about the VOBU, for instance during trick play.

The navigation field comprises an entry where the logical block number of the navigation field is stored.

When a section of a data stream stored in a VTS block is transferred to another device the data stream is retrieved from the VOB block using the information stored in the VTSI block. The data stream then no longer comprises any information previously stored in the VTSI block or navigation fields. A completely new VTS block is created where the VTSI information and the navigation fields are recreated based on the processing of the data stream for creating a new VTS block for transfer.

This has the disadvantage that when creating a new VTS block suitable for transfer to another device any embedded information that was embedded in the VTS block is lost and a complete processing of the data stream to create a proper new VTS block must be performed, requiring substantial processing power.

It is the objective of the present invention to overcome the disadvantage and provide a method for creating a new VTS while avoiding the loss of embedded information and lowering the processing requirement.

To achieve this objective the present invention is characterized in that in the transfer file the Relative Logical Block Number of each navigation field in the data block is recalculated relative to a first Logical Block Number of the data block in the transfer file.

Instead of extracting the data stream, the VOBUs of the VOB block are left intact and only the single entry of the Logical block number is recalculated. By only performing processing on the Logical Block Numbers of the navigational fields, a reduction is required processing power is achieved since less operations are required, and since no processing is performed on the other entries in the navigation fields nor on the VTSI block the loss of embedded information is avoided, thus achieving the objective of the invention.

The invention is based on the realization that by recalculating only the Logical Block Numbers of the navigation fields a VTS block is created that is acceptable to recording devices and can easily be handled by those recording devices when recording. Further more the processing by the player is also minimal compared to the complete extraction of a section of the data stream and subsequently processing this extracted section of the data stream in order to recreate an acceptable VTS block

A further embodiment of the invention is characterized in that the first Logical Block Number of the data file is assigned the value 0.

The recalculation of the Logical Block Numbers of the navigation field is required because the reference point for the Logical block number of the navigational field is the first Logical Block Number of the data block. When a section of a VOB block is selected where the first Logical Block Number of the section to be transferred does not coincide with the first Logical Block of the data block the Logical Block Numbers of the navigation fields of the section to be transferred will have an offset which must be removed in order to obtain a valid VTS block suitable for transfer.

The offset can be easily removed with software algorithms well known to the person skilled in the art by subtracting the Logical Block Number (of the first Logical Block) of the section to be transferred from every Logical Block Number in the section to be transferred. This effectively means that the first Logical Block Number becomes 0.

The VOB block thus obtained after recalculation of the Logical Block Numbers is appended to the VTSI block and together form a valid VTS block.

A further embodiment relating to a method for recording a transfer file created using the method as claimed in claim 1, is characterized in that on a destination rewritable DVD video disc the transfer file is appended to the end of the data on the destination DVD and a VMG block is updated to include information on the added transfer file

When recording a transfer file as obtained by the present invention the transfer file, i.e. VTSI block and VOB block can be directly, without processing, be appended to the end of the data on the destination disc because the transfer file is already compliant with the DVD video standard. The only additional action required for proper recording is the updating of the VMG area on the DVD disc such that the existence of the newly added transfer file is indicated.

A further embodiment relating to a method for recording a transfer file is characterized in that on a destination rewritable DVD disc containing the DVD+VR format, the information block comprised in the transfer file is merged with the VTSI block and the VMG block on the destination rewritable DVD and the data block comprised in the transfer file is appended to the VOB region on the destination DVD+RW and that the Relative Logical Block Number of each navigation field in the data block is recalculated relative to a first Logical Block Number of the first data block of the VOB region.

This embodiment is based on the same recognition as claim 1, i.e. instead of extracting the data stream and thus losing all embedded information and having to process the data stream from scratch to obtain the VTSI and VOB blocks suitable for recording the transfer file is only processed to the extend that the Logical Block Numbers of the navigation fields are recalculated.

It is important to note that the transfer file in this embodiment does not have to be the transfer file of claim 1. Any file containing the VTSI block and the VOB block can be processed and made suitable for recording. As a matter of principle the recalculation can be performed either after extraction of the section of the data stream but before the creation of the transfer file, or alternatively a transfer file is created without any processing and the processing is performed by the recorder in order to prepare the recording of the section of the data stream. In both cases the amount of processing is reduced compared to the state of the art, the embedded information is preserved, and data in a format suitable for recording is obtained.

Because the DVD+VR standard requires the Logical Block Numbers to be relative to the first Logical Block Number of the first VOB block in the first VTS block, the offset of the navigation fields in the data block to be recorded must be recalculated in order to reflect the new offset. Since the offset of the Logical Block Number depends on the amount of Logical Blocks already used on the recording medium, only the recorder can perform this recalculation of Logical Block Numbers of the data block to be recorded.

The algorithm to implement the offset is well known to the person skilled in the art and essentially consists of the addition of a constant positive or negative value to every Logical Block Number of the navigation fields of the data block.

In order to comply with the DVD+VR standard the information block must be merged with the VMG block and VTSI block already existing on the recording medium. In this way the presence of the newly added data is indicated on the disc.

A further embodiment relating to a method for recording a transfer file created using the method as claimed in claim 1 is characterized in that on a destination recordable DVD disc containing the DVD+VR format, the data block comprised in the transfer file is appended to the VOB region on the destination recordable DVD and the information block comprised in the transfer file is merged with the VTSI block and the VMG block from the destination rewritable DVD and appended to the appended data block in the form of a VTSI backup block and VMG backup block and that the Relative Logical Block Number of each navigation field in the data block is recalculated relative to a first Logical Block Number of the first data block of the VOB region.

It must be noted that entries are comprised in the VTSI block that also need to be updated, for instance the VTS VOBU Address Map and the VTS Cell Address Table.

In the VMGI block there are entries that need to be updated, for instance the VMGM Cell Address Table and the VMGM VOBU Address Map.

Since the implementations of how to generate these entries, based on the VOBUs obtained via the method of the present invention, is described in great detail in the DVD specification a description is not repeated here.

The invention will now be discussed based on figures.

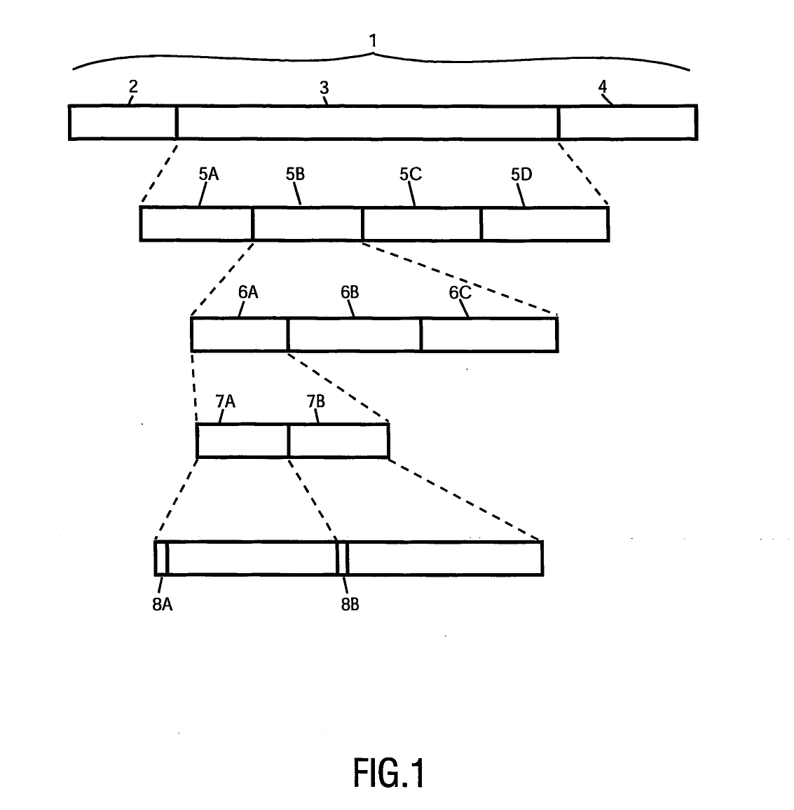

FIG. 1 shows the structure of the data on a DVD disc.

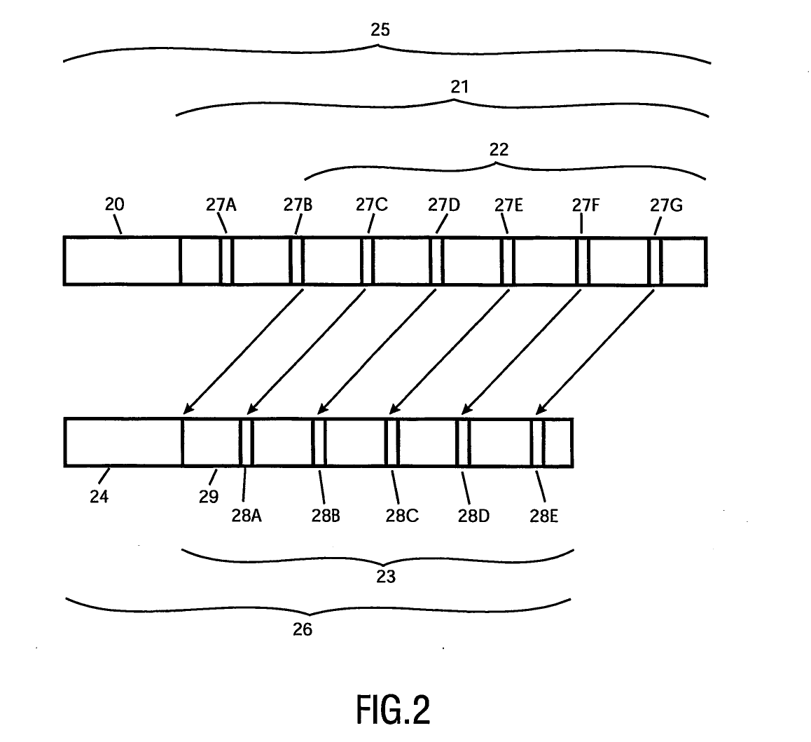

FIG. 2 shows the recalculation of the logical block number of the transfer file according to the invention.

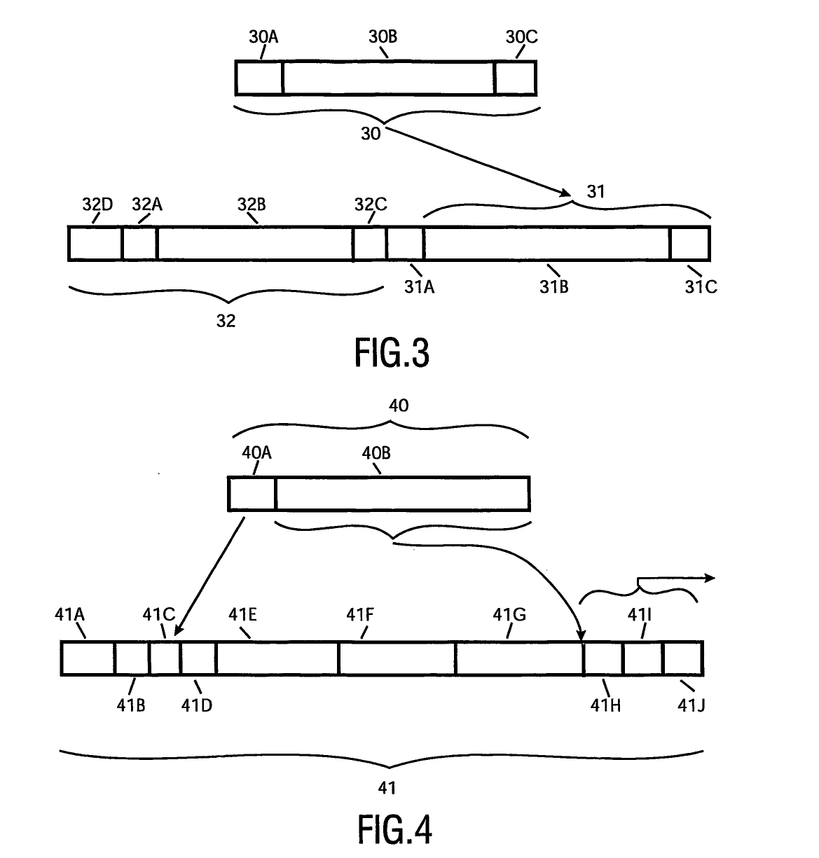

FIG. 3 shows the insertion of the transfer file on a rewriteable DVD disc with the DVD Video format.

FIG. 4 shows the insertion of the transfer file on a rewriteable DVD disc in the DVD+VR format.

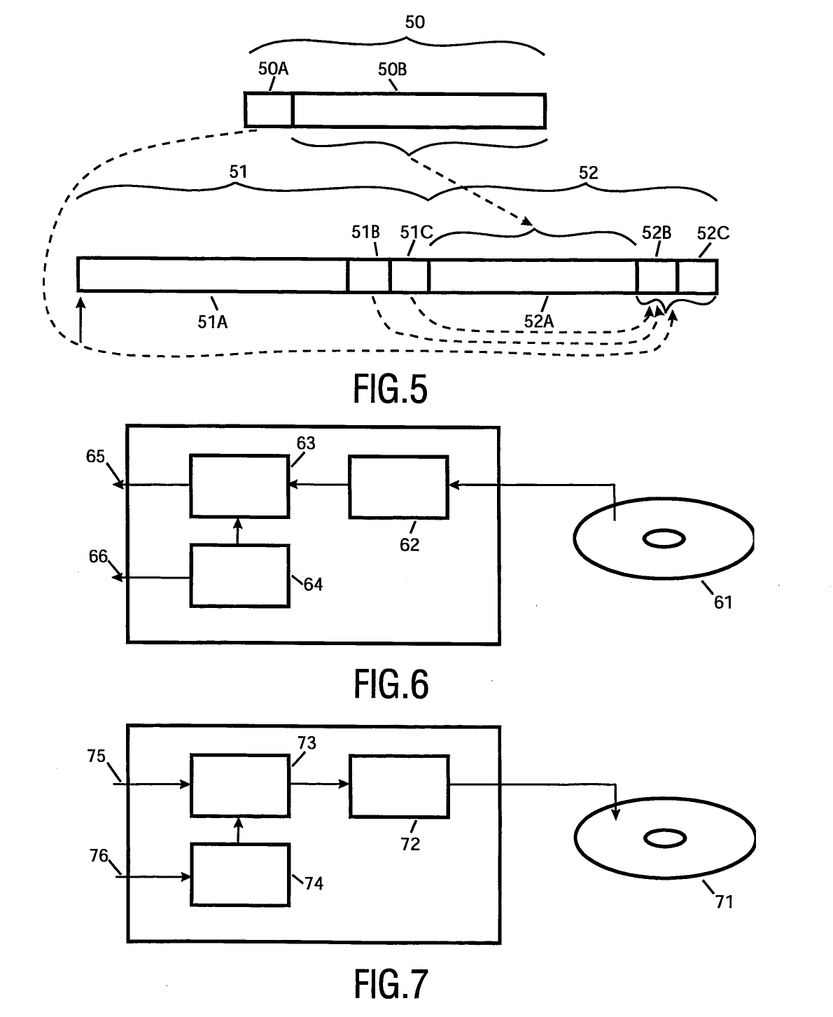

FIG. 5 shows the insertion of the transfer file on a recordable DVD disc in the DVD+VR format.

FIG. 6 shows a play back device comprising the invention

FIG. 7 shows a recorder comprising the invention.

FIG. 1 shows the structure of the data on a DVD disc.

The VTS block 1 comprises a VTSI block 2 and a VOB block 3 and a backup of the VTSI block called the BUP block 4. The VOB block 3 comprises VOBU blocks 5a. 5b, 5c, 5d. A Vobu 5a, 5b, 5c, 5d comprises a navigation pack 6a and one or more video packs 6b and audio packs 6c. The navigation pack 6a comprises a Program Control Information field 7a and a Data Search Information field 7b. The first entry 8a in the Program Control Information field 7a is the Logical Block Number of the Navigation pack 6a. The first entry 8b in the Data Search Information field 7b is the same Logical Block Number of the navigation Pack 6a. The Logical Block Number in the first field 8a, 8b of the Program Control Information field 7a and the Data Search Information field 7b is expressed relative to the Logical Block Number of the first Logical Block of the VOB block.

FIG. 2 shows the recalculation of the logical block number of the transfer file according to the invention.

The VTS block 25 comprises a VTSI block 20 and a VOB block 21. A section 21 of the VOB block 20 is to be copied to a transfer file 26. In order to accomplish this the logical block numbers of the navigation packs 27c, 27d, 27e, 27f, 27g have to be recalculated. The resulting new navigation packs 28a, 28b, 28c, 28d, 28e replace the old navigation packs 27c, 27d, 27e, 27f, 27g. the first navigation pack 27b of the section 22 to be transferred is not copied because the first VOBU 29 starts at offset 0, i.e. with logical Block Number 0.

In the example given in FIG. 2 the offset to be removed is 400, this means that from the logical block numbers of the navigation packs 27c, 27d, 27e, 27f, 27g an offset of 400 is subtracted. The VTSI block 20 must be updated as well since less VOBUs are present and the locations of the navigation packs 28a, 28b, 28c, 28d, 28e is different from the original locations of the navigation packs 27c, 27d, 27e, 27f, 27g. The resulting VTSI block 24 is used to construct the transfer file 26. The update of the VTSI block 20 is straight forward, following the requirements of the DVD standard for VTS blocks. For instance in the list of VOBs, VOBUs and cells the entries for the removed VOBs, VOBUs, and cells must be removed. In the list of navigation packs the entries for navigation packs no longer present 27a, 27b must be removed and the entries of the remaining navigation packs 28a, 28b, 28c, 28d, 28e must be updated to reflect their new locations.

FIG. 3 shows the insertion of the transfer file on a rewriteable DVD disc with the DVD Video format.

When the VTS block 30 in the transfer file as received by the recorder is to be appended to an existing VTS block 32 in the DVD video format on a DVD+RW disc, the file can be appended, without modification, to the existing VTS block 32. The VTSI block 31a of the appended VTS file does not need to be changed compared to the VTSI block 30a of the transfer file 30. The same applies to the VOB block 31b and BUP block 31c, no modification is needed compared to the VOB block 30b and the BUP block 30c of the transfer file 30.

Also the VTSI block 32a, VOB block 32b and BUP block 32c of the existing VTS block 32 can remain unchanged. The only modification needed is the update of the VMG block 32d of the VTS block 32 in order to reflect the appended VTS block 31.

It is self evident that the transfer file can be created by the source before being put into the transfer file, i.e. before transmission to the recorder, or that a improperly prepared VTS block that was transferred to the recorder can be processed in the recorder using the method of the present invention. Having the VTS block in the proper format allows easy recording of the VTS block, regardless of where the method of the present invention was applied.

FIG. 4 shows the insertion of the transfer file on a rewriteable DVD disc in the DVD+VR format.

When the VTS block 40 in the transfer file as received by the recorder is to be appended to an existing VTS block 41 in the DVD+VR format on a DVD+RW disc, the information in the VTSI block 40a of the VTS block 40 must be merged with the appropriate VTSI block 41b, 41c, 41c of the VTS block 41 on the DVD. The merging consists of adding the entries in each field of the VTSI block 40a in the transfer file to the corresponding entries of the VTSI block 41b on the DVD. There are three VTSI blocks 41b, 41c, 41d on the DVD each for a different screen ratio and the information from the VTSI block 40a in the transfer file must be merged with the VTSI block 41b, 41c, 41d having the same screen ratio as the VTS block 40 in the transfer file.

In addition the VOB block 40b of the VTS block 40 in the transfer file must be appended to the existing VOB blocks 41e, 41f, 41g on the DVD. As a consequence the BUP blocks 41h, 41i, 41j on the DVD must be moved away from the last existing VOB block 41g on the disc in order to provide room for the VOB block 40b from the transfer file. The VOB block 40b from the transfer file is appended to the last VOB block 41g on the DVD. The BUP blocks 41h, 41i, 41j are then located directly behind the inserted VOB block. Since the BUP blocks 41h, 41i, 41j are backup copies of the VTSI blocks 41b, 41c, 41d the updates applied to the VTSI blocks 41b, 41c, 41d because of the inserted VOB block must also be applied to the BUP blocks 41h, 41i, 41j. This can be effected by applying the update to the BUP blocks 41h, 41i, 41j or by simply copying the VTSI blocks 41b, 41c, 41d to the location of the BUP blocks 41h, 41i, 41j.

The VMG block 41a does not need to be updated.

FIG. 5 shows the insertion of the transfer file on a recordable DVD disc in the DVD+VR format.

When the VTS block 40 in the transfer file as received by the recorder is to be appended to an existing VTS block 41 in the DVD+VR format on a DVD R disc. The following description will work with both DVD+R and DVD−R discs as long as the disc is not finalized.

The VTS block 50 from the transfer file comprises a VTSI block 50a and a VOB block 50b.

The VOB block 50a of the transfer file is appended to the existing VTS block 51 on the disc and is shown as the appended VOB block 52a in FIG. 5.

The VTSI block is merged as described for FIG. 4 with the last VTSI block 51c on the disc resulting in a merged VTSI block. The VMG block 51b on the disc is updated and appended to the appended VOB block 52a. The merged VTSI block 52c is appended to the appended and updated VMG block 52b.

When the disc is to be finalized the VMG block 52b and VTSI block 52c at the end of the disc are copied to the first section of the disc. This is identical to the normal finalization of the DVD−R and DVD+R and is well documented in the corresponding DVD standards.

The logical block numbers of the navigation packs in the inserted VOB block 52a have to be recalculated. The resulting new navigation packs replace the old navigation packs.

The Logical Block Numbers of the navigation packs must be recalculated relative to the reference point of Logical Block Number 0 which is the first Logical Block Number of the first VOB block on the disc.

FIG. 6 shows a play back device comprising the invention

The playback device 60 for playing back the data recorded on the record carrier 61 comprises the bit engine 62 which is responsible for the processing of the code words coming from the record carrier in such a way that the extracted code words are suitable for processing by the processing means 63. The processing means 63 comprises all means for extracting the VTS information and VOB block from the code words provided by the bit engine 62. For this the processing means 63 comprises decoders, buffers, controlling means for controlling the decoding process, controlling means for controlling the playback device and interfacing with the user through a user interface. The elements of the processing means are so well known to the person skilled in the art that they are not shown in FIG. 6 and need no detailed description. The processing means 63 processes the code words and extracts the data stream from the VOB blocks using the information provided by the VTS information and information from the VOB blocks. The processing means 63 then extracts the data stream in MPEG format from the VTS information and VOB blocks and provides the data stream in MPEG format to a first output 65 for regular transfer to peripheral devices.

The processing means also provides the VTS information and VOB blocks to the transfer file creation means 64, which is essentially a processor that receives the VTS information and VOB blocks and creates a transfer file comprising a modified VTS block and modified VOB block. The creation of the transfer file uses the method as explained in FIG. 2. A universal file is created where the offset of the navigation packs is corrected to reflect the new position relative to the beginning of the file and the VTS information is updated to reflect the new locations of the navigation packs and updated reflecting the VOBUs present in the VOB block. The transfer file thus created is provided to a second output 66 for transfer to another device.

FIG. 7 shows a recorder comprising the invention. The recorder 70 comprises a first input 75 arranged for receiving a regular MPEG data stream. The regular MPEG data stream is provided to the processing means 73 for the creation of VOB blocks and of VTS information in a VTS block The VTS block and VOB block are then encoded into code words which are provided to the bit engine 72. The bit engine 72 processes the code words provided by the processing means 73 such that they are suitable for recording on the recording medium 71.

The processing means can also receive VOB blocks and VTS blocks from the transfer file processing means 74 which is arranged to receive VTS blocks and VOB blocks from a second input 76. The transfer file processing means 74 can accept any VTS block and corresponding VOB block. The processing of the VTS block and corresponding VOB block is performed as explained in FIG. 3, FIG. 4 or FIG. 5 depending on the type of recording medium and video format used in conjunction with the recording medium.

Since the processing is done by the recorder, the VTS block and corresponding VOB block does not have to be processed according to the invention before it arrives at the transfer file processing means 74 since the transfer file processing means can easily remove any existing offset and update the VTS block and VOB block accordingly.

Also, because the transfer file processing means is aware of the type of recording medium and the video format used the correct measures as explained in FIG. 3, FIG. 4 or FIG. 5 can be selected for the processing of the received VTS block and corresponding VOB block. The processed VTS block and corresponding VOB block are then provided to the processing means 73 where only the channel encoding has to be applied to obtain the code words suitable for processing by the bit engine in the regular fashion.

1. Method for creating a transfer file, the file comprising an information block comprising information on a data block and the data block comprising a navigation field and the navigation field comprising a Relative Logical Block Number of the navigation field,
the method comprising the steps of
creating a transfer file by appending the data block to the information block
characterized in that in the transfer file the Relative Logical Block Number of each navigation field in the data block is recalculated relative to a first Logical Block Number of the data block.

2. Method for creating a transfer file for transferring a section of a data stream stored in a file as claimed in claim 1, characterized in that the first Logical Block Number of the data file is assigned the value 0.

3. Method for creating a transfer file for transferring a section of a data stream stored in a file as claimed in claim 2, characterized in that the recalculated Logical Block Number is stored in a data search information field and a Program Control Information field.

4. Method for creating a transfer file for transferring a section of a data stream stored in a file as claimed in claim 1 characterized in that the section of the data stream comprises a DVD title or a DVD chapter.

5. Method for creating a transfer file for transferring a section of a data stream stored in a file as claimed in claim 1, characterized in that the file comprises one or more VOB blocks in a DVD format

6. Method for creating a transfer file for transferring a section of a data stream stored in a file as claimed in claim 1, characterized in that the information block is a VTSI block in the DVD format

7. Method for creating a transfer file for transferring a section of a data stream stored in a file as claimed in claim 1, characterized in that the data block comprises one or more VOBU blocks in the DVD format

8. Method for creating a transfer file for transferring a section of a data stream stored in a file as claimed in claim 1, characterized in that the navigation field is a NV_PCK field in the DVD format

9. Method for recording a transfer file created using the method as claimed in claim 1,
characterized in that on a destination rewritable DVD video disc the transfer file is appended to the end of the data on the destination DVD and a VMG block is updated to include information on the added transfer file

10. Method for recording a transfer file created using the method as claimed in claim 1,
characterized in that on a destination rewritable DVD disc containing the DVD+VR format, the information block comprised in the transfer file is merged with the VTSI block and the VMG block on the destination rewritable DVD and the data block comprised in the transfer file is appended to the VOB region on the destination DVD+RW and that the Relative Logical Block Number of each navigation field in the data block is recalculated relative to a first Logical Block Number of the first data block of the VOB region.

11. Method for recording a transfer file created using the method as claimed in claim 1,
characterized in that on a destination recordable DVD disc containing the DVD+VR format, the data block comprised in the transfer file is appended to the VOB region on the destination recordable DVD and the information block comprised in the transfer file is merged with the VTSI block and the VMG block from the destination rewritable DVD and appended to the appended data block in the form of a VTSI backup block and VMG backup block and that the Relative Logical Block Number of each navigation field in the data block is recalculated relative to a first Logical Block Number of the first data block of the VOB region.

12. Recorder for recording a data stream using the method as claimed in claim 9.

13. Play back device for playing a data stream using the method for creating a transfer file as claimed in claim 1.
